(19) United States
(12) Patent Application Publication
(10) Pub. No.: US 2007/0221770 A1
(43) Pub. Date: Sep. 27, 2007

(54) Spice grinding device with a rotatable handle

(76) Inventor: Shun-I Cheng, Yeuong-Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/387,739

(22) Filed: Mar. 24, 2006

(51) Int. Cl. A47J 42/00

(52) U.S. Cl. 241/169.1

(57) ABSTRACT

A spice grinding device includes a hollow body with an open top, and a cap is connected on the top of the hollow body. A grinding blade unit is received in the hollow body and a shaft with a polygonal cross section is connected to the grinding blade unit. A driving mechanism is securely connected to the shaft and a handle located on a side of the hollow body is connected to the driving mechanism. When rotating the handle, the shaft is rotated to operate the grinding blade unit to grind peppers in the hollow body. Because the handle is located at a side of the spice grinding device, the user's elbow does not expand outward.

### FIELD OF THE INVENTION

The present invention relates to a spice grinding device such as a pepper mill having a handle pivotably connected to a driving mechanism in the cap of the mill so as to rotate the grinding blade, the handle is located a side of the mill.

### BACKGROUND OF THE INVENTION

A conventional spice grinding device such as a pepper mill is shown in FIG. 1 and generally includes hollow body 10 and a cap which is rotatably connected on a top of the hollow body 10. A grinding blade unit 40 is received in a bottom member which is threadedly connected to a lower end of the hollow body 10. The grinding blade unit 40 is connected with a shaft 30 with rectangular cross section and the shaft 30 is securely connected to the cap 20. The user holds the hollow body 10 by one hand and rotates the cap 20 by the other hand to operate the grinding blade unit 40 to grind pepper in the hollow body 10. The hollow body 10 generally made to be a tubular hollow body and is boring for its contour.

Another conventional pepper mill is shown in FIG. 2 and generally includes hollow body 10 and a grinding blade unit 40 is received in a lower portion of the hollow body 10. The grinding blade unit 40 is connected with a shaft 30 with rectangular cross section and the shaft 30 is securely connected to the handle 50 which is located a top of the hollow body 10. The user holds the hollow body 10 by one hand and rotates the handle 50 by the other hand to operate the grinding blade unit 40 to grind pepper in the hollow body 10. When the user wants to operate the handle 50, the elbow of the hand holding the handle 50 has to be posed outward and this might affect the person next to you.

The present invention intends to provide a spice grinding device such as a pepper mill which includes a handle located a side of the hollow body and is rotated about a horizontal axis so that the elbow of the user does not need to expand outward.

### SUMMARY OF THE INVENTION

The present invention relates to a spice grinding device which comprises a hollow body with an open top. A grinding blade unit is received in the hollow body and includes a grinding blade. A shaft with a polygonal cross section is connected to the grinding blade unit. A cap is connected to the hollow body. A driving mechanism is securely connected to the shaft and a handle located on a side of the hollow body is connected to the driving mechanism.

The primary object of the present invention is to provide a spice grinding device with a handle located at a side of the body of the spice grinding device and the handle drives a driving mechanism to operate the grinding blade unit. The handle is located such that the user does not expand his or her elbow outward.

Another object of the present invention is to provide a spice grinding device which is decorated as an elephant and the handle is decorated as an elephant nose.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional spice grinding device;

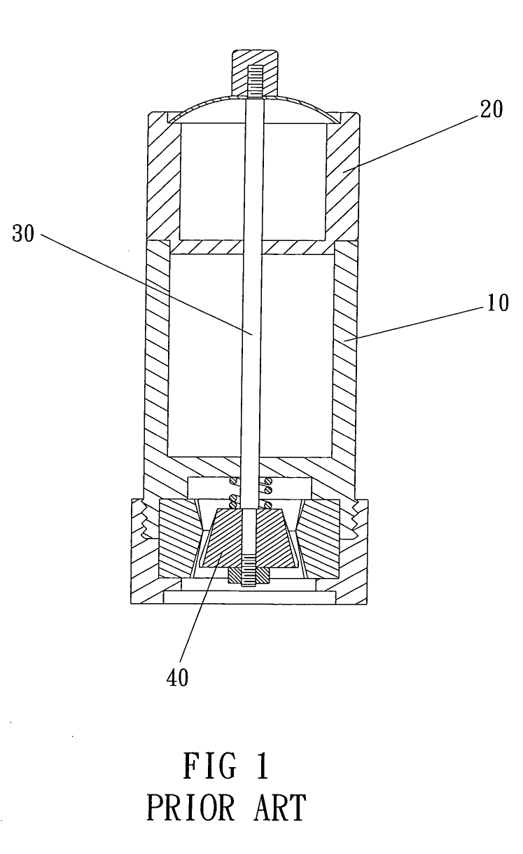

FIG. 2 is a cross sectional view to show another conventional spice grinding device;

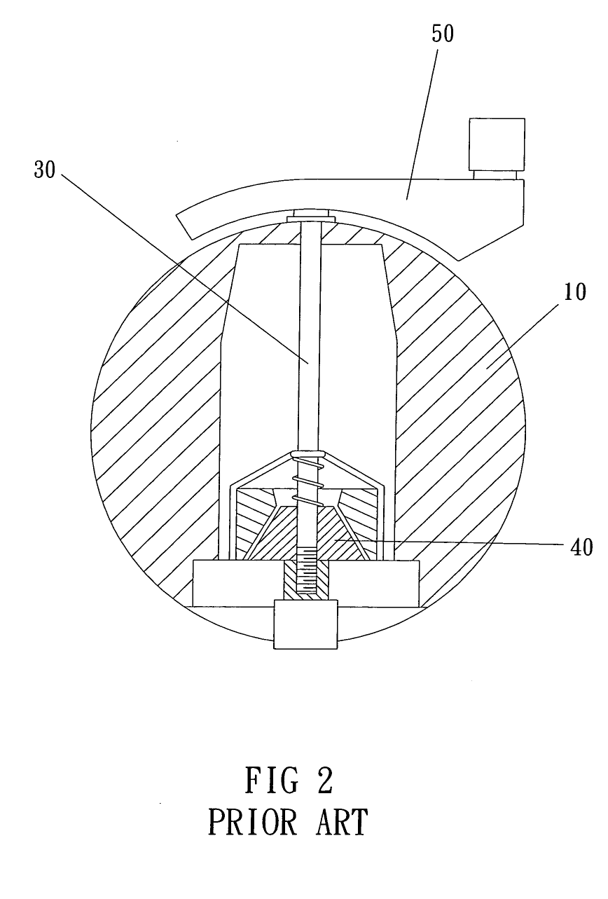

FIG. 3 is a perspective view to show the spice grinding device of the present invention;

FIG. 4 is a cross sectional view to show the spice grinding device of the present invention, and

FIG. 5 is a top view to show the driving mechanism of the spice grinding device of the present invention.

### DETAILED DESCRIPTION OF THE PREFERRED EMBODIMENT

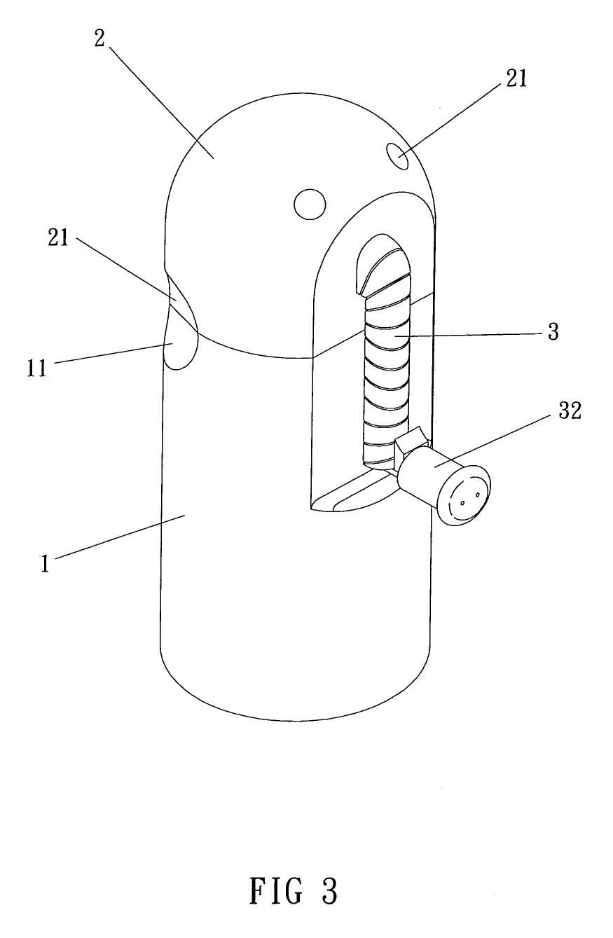

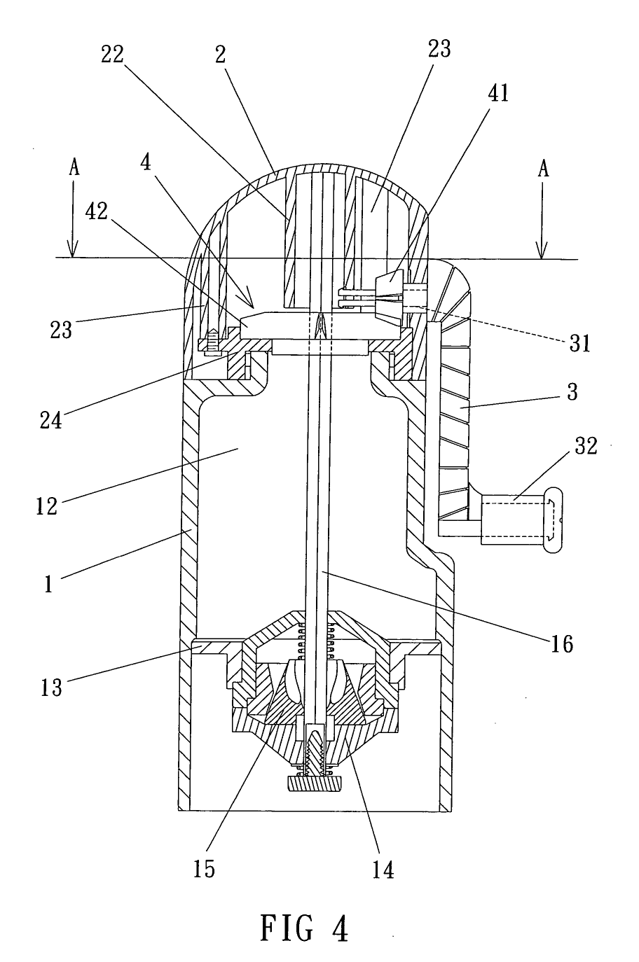

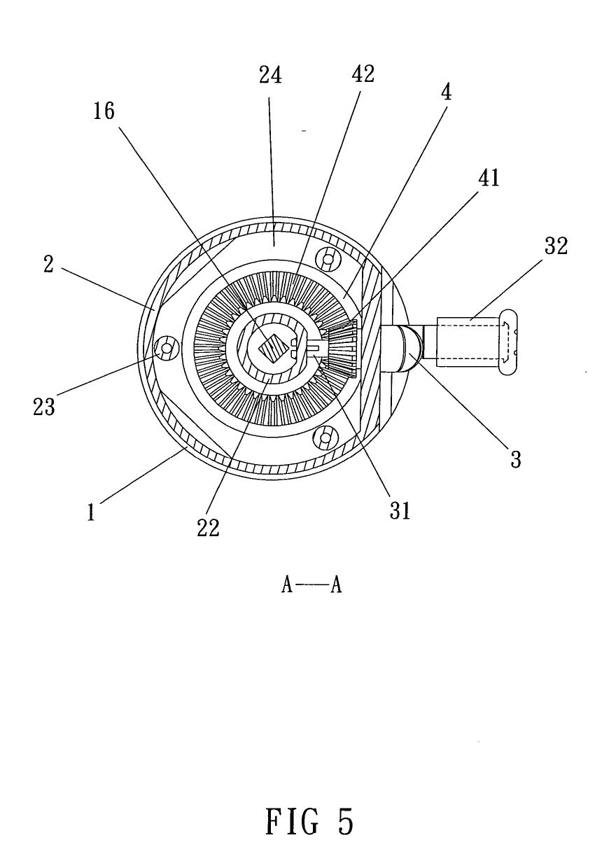

Referring to FIGS. 3 to 5, the spice grinding device of the present invention comprises a hollow body 1 with an open top. Pepper or mineral salt (not shown) can be received in the interior 12 of the hollow body 1. A grinding blade unit 14 is received in the hollow body 1 and connected to a connection board 13 located in a lower portion of the hollow body 1. The grinding blade unit 14 includes a grinding blade 15 and a shaft 16 with a polygonal cross section is connected to the grinding blade unit 14.

A cap 2 is connected to a top of the hollow body and includes a receiving tube 22 in which a distal end of the shaft 16 is located. A plurality of connection tubes 23 extend from an inner end thereof and a board 24 is fixedly connected to the connection tubes 23 by bolts extending through the board 24 and threadedly connected to the connection tubes 23. The board 24 is transversely connected in the cap 2 so as to position a driving mechanism 4 in the cap 2.

The hollow body 1 has a pre-determined length of first flat surface extending from the top thereof and the cap 2 has a second flat surface which is in alignment with the first flat surface. The hollow body 1 has two first recesses 11 (only one is shown) defined in an outer periphery of the top thereof and the cap 2 has two second recesses 21 (only one is shown) defined in an outer periphery of a lower portion thereof. The two respective first recesses 11 and the second recesses 21 communicate with each other. The aligned first and second recesses 11, 21 are located opposite to the first and second flat surfaces.

A handle 3 connected to the driving mechanism 4 and located on a side of the hollow body 1. The handle 30 is located at distance from the alignment first and second flat surfaces. The first end 31 of the handle 3 extends into the cap 2 and is perpendicular to a body of the handle 3, the body of the handle 3 is oriented in parallel to the shaft 16, and a grip 32 is rotatably mounted to a second end of the handle 3 and the grip 32 is perpendicular to the body of the handle 3.

The driving mechanism 4 includes a first bevel gear 41 connected to a first end 31 of the handle 3 and a second bevel gear 42 which is connected on the board 24 and securely connected to the shaft 16. The second bevel gear 42 is engaged with the first gear 41.

The user may hold the grip 32 and rotates the handle 3 about the first end 31 of the handle 3 so that the first bevel gear 41 drives the second bevel gear 42. The shaft 16 is rotated and the grinding blade unit 14 is operated to grind the peppers and the user may enjoy the fresh ground pepper. It is noted that the user's elbow does not expand outward because the handle 3 is pivoted about the horizontal first end 31 of the handle 3.

Besides, the spice grinding device is decorated as an elephant, wherein two dents 21 are defined in the cap 2 and close to the first flat surface in the cap 2, the aligned first and second recesses 11, 21 look like the ears of the elephant, and the handle 3 is decorated as the elephant nose.

While we have shown and described the embodiment in accordance with the present invention, it should be clear to those skilled in the art that further embodiments may be made without departing from the scope of the present invention.

What is claimed is:

1. A spice grinding device comprising:
a hollow body with an open top;
a grinding blade unit received in the hollow body and including a grinding blade, a shaft with a polygonal cross section being connected to the grinding blade unit;
a cap connected to the hollow body and a top of the shaft extending into the cap;
a driving mechanism securely connected to the shaft and including a first bevel gear and a second bevel gear which is securely connected to the shaft and engaged with the first bevel gear, and
a handle connected on a side of the hollow body and the first bevel gear connected to the handle of the driving mechanism.

2. The spice grinding device as claimed in claim 1, wherein a board is transversely connected in the cap and the second bevel gear is connected on the board, the first bevel gear is connected to a first end of the handle.

3. The spice grinding device as claimed in claim 2, wherein the cap includes a plurality of connection tubes extending from an inner end thereof and the board is fixedly connected to the connection tubes by bolts extending through the board and threadedly connected to the connection tubes.

4. The spice grinding device as claimed in claim 2, wherein the first end of the handle extends into the cap and is perpendicular to a body of the handle, the body of the handle is oriented in parallel to the shaft.

5. The spice grinding device as claimed in claim 4, wherein a grip is rotatably mounted to a second end of the handle and the grip is perpendicular to the body of the handle.

6. The spice grinding device as claimed in claim 1, wherein the hollow body has a pre-determined length of first flat surface extending from a top thereof and the cap has a second flat surface which is in alignment with the first flat surface, the handle is located at distance from the alignment first and second flat surfaces.

7. The spice grinding device as claimed in claim 6, wherein the hollow body has at least one first recess defined in an outer periphery of the top thereof and the cap has at least one second recess defined in an outer periphery of a lower portion thereof, the at least one first recess and the at least one second recess communicate with each other and are located opposite to the first and second flat surfaces.
